(19) United States
(12) Patent Application Publication
(10) Pub. No.: US 2011/0290469 A1
(43) Pub. Date: Dec. 1, 2011

(54) INSTALLATION FOR HOMOGENIZATION OF TEMPERATURE IN AN ENCLOSURE

(76) Inventor: Rafael POLANCO MUÑOZ, Chiclana (Cadiz) (ES)

(21) Appl. No.: 13/151,452

(22) Filed: Jun. 2, 2011

Related U.S. Application Data
(63) Continuation of application No. PCT/ES2009/070536, filed on Nov. 27, 2009.

(30) Foreign Application Priority Data
Dec. 5, 2008 (ES) P200803458

(51) Int. Cl. F24F 7/007; G05D 23/00

(52) U.S. Cl. 165/254; 165/59

(57) ABSTRACT

It has been forecasted for its mounting at the vent of an air conditioning equipment (1), and comprises two independent ducts (2 and 3), one of them with its vent at the upper part of the enclosure and the other with its vent at the lower part of the same enclosure. At the intersection zone between the equipment (1) and the ducts (2 and 3), two couples of grilles (5 and 6) capacitated for occupying two positions are mounted, in order to establish the respective canalizations (10 and 11) for directing cold air or hot air (depending on whether the equipment 1 is producing cold air or producing heat) toward the upper part of the duct (2) or toward the lower part of the duct (3), respectively, establishing is both cases the cold air or hot air return at the lower part of one or other duct.

This Application is a continuation application of International Application PCT/ES2009/070536, filed Nov. 27, 2009, which is hereby incorporated by reference in its entirety.

### OBJECT OF THE INVENTION

The present invention, as this specification states in its title, relates to an installation for homogenization of temperature in an enclosure, which has been conceived and made in order to prevent classical temperature stratification originated in an enclosure or living space when a cold air or hot air equipment is operating, which vents as well as its return are established at the upper part.

Therefore, the object of the invention is achieved, at the minimal possible time and also with a minimal energy cost, the optimum comfort of a living space when cold air or hot air proceeding from a cooling equipment or heater is being applied to it.

### BACKGROUNDS OF THE INVENTION

As it is known, cooling or heating systems or equipments, operated either in cold or heat, apply air to the living space through a grille placed at the upper part, next to the ceiling, such that the returns is also performed at the upper part.

Therefore, as a consequence of that return air collection at the upper part, the produced cold reaches the lower zone when the equipment is operating as a cooling system, whereby the living space is further cooled at said lower zone, causing an environmental stratification in the living space itself, which forces the equipment to a high energy cost in order to equal the ambient temperature and disappear as far as possible such stratification, i.e. in order to achieve a comfortable environment in the entire living space.

If the equipment operates as a heating system, the same occurs but in reverse, i.e. the hot air which is driven by the grille placed at the upper part will firstly occupy the zone immediately bellow the ceiling, equally causing the stratification although in this case more stressed by the tendency of the hot air to rise, whereby the lower zone will be more cold and, the equipment should be operated more time than the one needed, with the consequent energy cost in order to achieve the comfort or temperature leveling between the upper and lower parts.

Accordingly, in accordance to that set forth, the operation in cold or heat requires that the equipment consumes more energy for achieving and maintaining the desired temperature in the living space, since a temperature stratification which should be compensated in order to achieve the comfort of the enclosure or leaving space properly speaking, is established therein.

Clearly, the stratification will also depend on the thermal insulation of the building and on the time that the equipment should remain operating.

### DESCRIPTION OF THE INVENTION

The installation object of the invention presents some peculiarities on which basis an optimum comfort for a living space in a minimal time, with air quality and without stratification, in either cooling operation or heating operation.

In such sense, the installation of the invention is characterized by comprising two ducts, one with a vent connected with the upper part and other with the vent connected with the lower part of the leaving space, all of this in such a way that the beginning of the ducts will be connected with the front part of the equipment for generating cold or heat.

On the other hand, it has been established that two couples of motorized grilles are mounted between said ducts and the equipment itself, which are placed for, depending on whether the equipment is operating for cold or operating for heat, establishing a canalization for vented air at the upper part and collection or return at the lower part, in the case of cold; or either establishing a canalization of vented air at the lower part, and collection or return at the upper part, in the case of heat.

In this way, the comfort of the leaving space in less time is achieved thus the energy cost for operating the equipment will be lower. This is, the energy saving can be considered high in comparison with conventional systems which do not incorporate the installation or the referred ducts, and this as a consequence that the cold or heat which is built up in the lower part as well as in the upper part, is recovered again in order to reusing it without leaving this energy stratifies in the leaving space, significantly reducing the consume produced once achieving the desired comfort temperature in the leaving space itself.

The installation is applicable by replacing currently installations in houses, premises, stores, hotels, hospitals, restaurants, etc., i.e. in all those places wherein ducts for air distribution in leaving spaces or enclosures are utilized.

It is also convenient to say that enclosures and leaving spaces with high number of people and with the installation of the invention result more beneficial since causing the stratification is prevented, which is very common when this enclosure or leaving space is occupied by a high number of people.

Lastly saying as a summary of the advantages obtained by applying the installation for homogenization of the temperature, a notable reduction of the equipment consume is achieved, since for maintaining the temperature will be needed less energy by virtue of that the energy of the hot air reaching the ceiling or of the cold in the floor, is driven back to the circuit; i.e. more moderate and efficient temperatures are achieved in the entire enclosure, without stratification, and very related to the energy cost needed at each time.

### BRIEF DESCRIPTION OF THE DRAWINGS

In order to complement the description that is going to be made bellow and with the object of helping to a better understanding of the characteristics of the invention, a set of drawings are attached to the specification on which basis the innovations and advantages of the installation object of the invention will be more easily understood.

FIG. 1.—Shows a scheme corresponding to the installation of the invention when the equipment is producing cold.

FIG. 2.—Shows a view as the one of the previous figure but in this case with the equipment operating in heat.

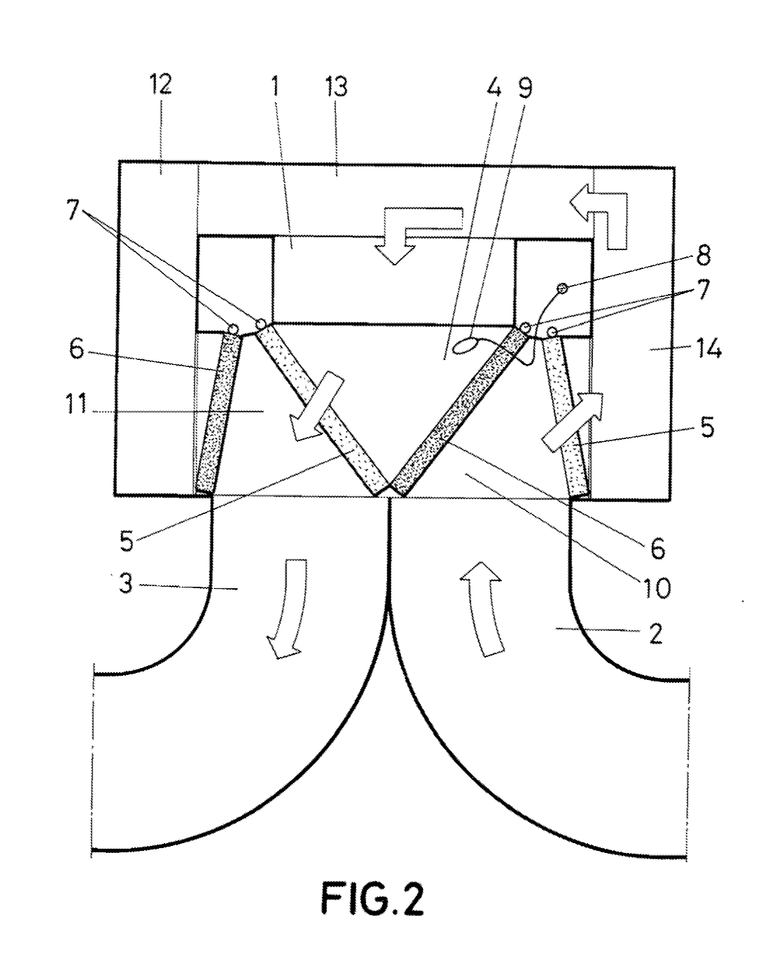

### PREFERRED EMBODIMENT OF THE INVENTION

As can be seen in the mentioned figures, the installation for homogenization of the temperature of an enclosure or living space wherein cold air or hot air generated by equipment 1 is applied, comprises two independent ducts 2 and 3, established in front of said equipment, namely next to a zone or section 4 wherein the equipment 1 drives out cold air or hot air, depending on whether the operation is for cooling or either the operation is for heating. In any case, in that zone or section of the duct 4, two pairs of motorized grilles 5 and 6 are provided, i.e. actionable by a motor 7 associated with each of them.

The installation further has a thermostat 8 associated with the corresponding sensor 9, such that depending on the operation of the equipment in cold or in heat, it will send the signal to either a pair or to the other of the grilles 5 and 6 in order to activate the motors and cause the closing of some grilles and the opening of the others.

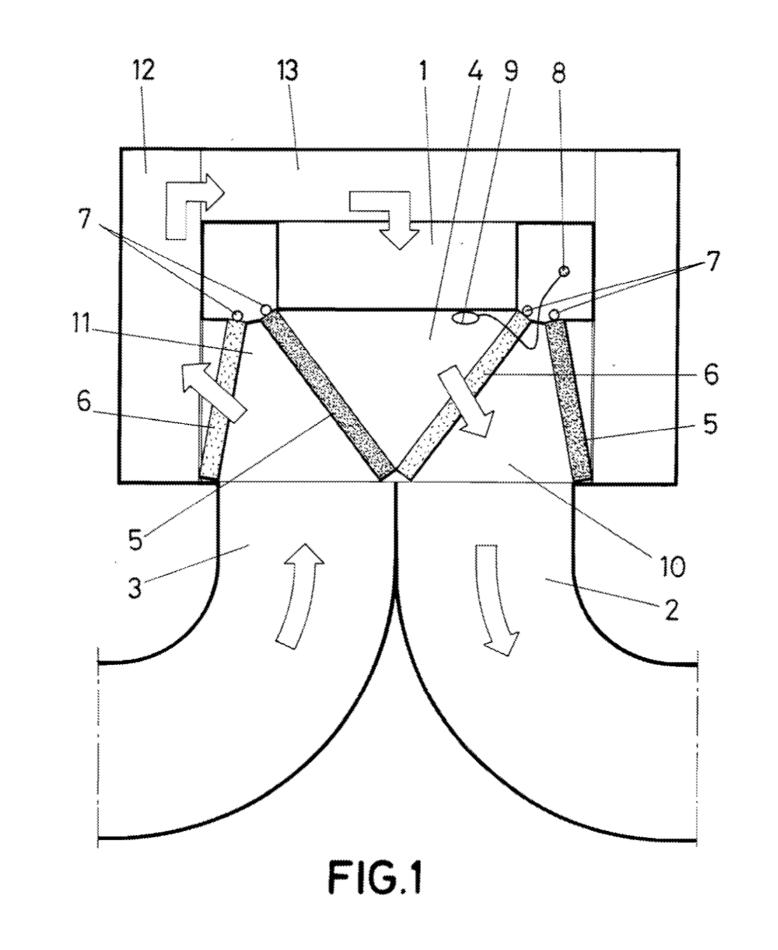

Namely, if the operation of the equipment 1 is for generating cold air, then the closing of grilles 5 and the opening of grilles 6 is produced, thus establishing a canalization 10 for directing the cold air vented by the equipment 1 to the duct 2 which vent will be provided at the upper part of the living space, whereas the cold air return or collection will be performed by the lower part of the duct 3, passing by another canalization 11 toward the duct 12 and from there to the duct 13 through which said cold air returns to equipment 1, such as the narrows of FIG. 1 indicate.

So now, if the operation of the equipment 1 is for generating heat, then the closing of grilles 6 and the opening of grilles 5 is produced, thus establishing that the hot air driven out by the equipment 1 be directed by canalization 11 toward the duct 3, which vent will be provided at the lower part, whereas the hot air return or collection will be performed by the upper part of the duct 2, passing through canalization 10 and from there to the duct 14 reaching the duct 13 from which the hot air returns again to equipment 1, such as the narrows of FIG. 1 indicate.

According to that set forth, and in any operating form, the air stratification is prevented, thus attaining quickly reaching the desired or comfort temperature, whereby the equipment time and operation are reduced and thus the energy consume or cost, being able to achieve up to 30% of saving, since the ambient air energy reached by the living space ceiling or the cold air energy reached by the floor, is driven back to the circuit of the corresponding equipment 1 which generates cold or hot air.

1. INSTALLATION FOR HOMOGENIZATION OF TEMPERATURE IN AN ENCLOSURE, being forecasted for its application at the vent of the air conditioning equipments, for both operating for producing cold and operating for producing heat, the cold air or hot air being driven out through a grille established for this effect in the living space wherein it is applied, characterized in that it comprises two independent ducts (2 and 3), one of them with its vent at the upper part of the living space and the other with its vent at the lower part of the same living space; having forecasted that between said ducts (2 and 3) and the corresponding equipment (1) which produces cold or heat, two couples of grilles (5 and 6) motorized and capacitated for occupying two positions are mounted, in order to establish, at the upper part, a canalization (10) with the vent of cold air through the duct (2) in one of the positions of said grilles (5 and 6), when the equipment (1) is producing cold, while the return or collection of said cold air is established by the lower part through the duct (3); whereas at the opposite position of said grille (5 and 6), a canalization (11) with the vent of hot air through the duct (3) is established at the lower part, while the return or collection of said hot air is established at the upper part through the duct (2).

2. INSTALLATION FOR STANDARDIZING TEMPERATURE IN AN ENCLOSURE, according to claim 1, characterized in that it includes a thermostat (8) for detecting temperature in order to establish the operation of the equipment (1) for generation cool, or in order to establish the operation of the equipment (1) for generation heat.

3. INSTALLATION FOR STANDARDIZING TEMPERATURE IN AN ENCLOSURE, according to claim 1, characterized in that the grilles (5 and 6) are independently actionable by the respective motors (7), simultaneously establishing the closing and opening in pairs.
